(19) United States
(12) Patent Application Publication
(10) Pub. No.: US 2008/0078509 A1
(43) Pub. Date: Apr. 3, 2008

(54) Noise-Reduced Motor-Driven Vertical Blind

(76) Inventor: Wei-Cheng YEH, Yanchao Shiang (TW)

Correspondence Address: Dr. BANGER SHIA;Int''l Patent Office of Bang Shia, 102 Lindencrest Ct, Sugar Land, TX, 77479-5201, US

(21) Appl. No.: 11/538,437

(22) Filed: Oct. 3, 2006

(51) Int. Cl. E06B 9/32

(52) U.S. Cl. 160/168.1 P

(57) ABSTRACT

A motor-driven vertical blind is provided with a restricting device disposed on the transmission shaft and a control device disposed on the transmission device. When curtain pieces held by the slide base move, the transmission device is in control of the swing angles: the transmission shaft will be blocked by the restricting device, whenever the output current of the motor increases above a normal range. Meanwhile, when the control device detects an overloading current, an “off” signal to stop the operation is transmitted to the motor.

### BACKGROUND OF THE INVENTION

1. Field of the Invention

The present invention relates to a blind. In particular, it relates to a motor-driven vertical blind with sustained durability and producing little machine noise in operation.

2. Description of the Related Art

Referring to FIG. 1 and FIG. 2, a conventional motor-driven vertical blind 1 comprised a top rail 11, a plurality of guide members 12 sliding in the top rail 11, a plurality of slide sets 13 sliding in the top rail 11, a plurality of connection members 14 (only one is illustrated in the figures) connected to the guide member 12 and the slide sets 13, and a transmission device 15 disposed on the top rail 11; a recess 111 is defined inside the top rail 11, and on the top rail 11 there is a channel 112 that permits the inside of the top rail 11 to communicate to the outside. A supporting wall 113 extends from two sides of the channel 112. Moreover, the guide members 12 are adjacently disposed and slide in the recess 111. Each guide member 12 has a guide hole 121 and a guide groove 122. Furthermore, a guide block 123 protrudes from the periphery of the guide hole 121, and a wing rib 124 protrudes from the guide groove 122.

To be more specific, every slide set 13 comprises a slide base 131 sliding in the recess 111 and a curtain piece 132 disposed on the slide base 131; the slide bases are arranged side by side therein. Each slide base 131 includes a base body 133, a rotation shaft 134 pivotally coupled to the base body 133 and connected to the curtain piece 132, a driving shaft 135 pivotally coupled to the base body 133 and connected to the rotation shaft 134, and a fastening block 136 protruding from the base body 133. A plurality of racks 1341 protrude from the rotation shaft 134 and between each rack forms a groove 1342 thereof. In addition, a partial groove 1342 is recessed with the blocking wall 1343.

Referring further to FIG. 3, the driving shaft 135 is composed of a hollow shaped inactive member 1351 and an active member 1352 which pivotally coupled to each other. A vortex sheet 1353 surrounds the outer periphery of the inactive member 1351, and a plurality of clasping blocks 1355 protrude from the inactive member 1351. A plurality of obstructing blocks 1354 are disposed on the active member 1352, corresponding to the clasping blocks 1355.

Referring to FIGS. 1, 2 and 4, two side edges of each connection member 14 project with a protruding block 141, so the connection member 14 couples with the wing rib 124 of the guide member 12, and at the same time, the fastening block 136 of the slide set 13.

Referring to FIG. 4, the transmission device 15 includes: (1) a thread shank 151 and a transmission shaft 152, both disposed in the recess 111, (2) a first gear 153 and a second gear 154, connected with the thread shank 151 and the transmission shaft 152, respectively, and (3) a motor 155 which drives the first gear 153 and the second gear 154; wherein the motor 155 is generated by an external power to drive the first gear set 153, the second gear set 154, the thread shank 151, and the transmission shaft 152 to rotate. While the thread shank 151 rotates, it can be held by the fastening block 135 to cause every slide base 131 to be displaced. The transmission shaft 152 penetrates through the driving shaft 135.

Referring to FIG. 1 and FIG. 2, while in use, the swings of the curtain piece 132 or the sliding of the slide base 131 is completely powered by the motor 155 to drive both the thread shank 151 and the transmission shaft 152. For instance, when the thread shank 151 is driven by the motor 155, the guide member 12 is guided by the thread shank 151, so the slide base 131 and the curtain piece 132 will be moved or displaced accordingly through the connection member 14.

In particular, when the transmission shaft 152 is powered by the motor 155, the transmission shaft 152 in turn drives the driving shaft 135 to rotate, and control the inactive member 1351, the active member 1352, the rotation shaft 134 and the curtain piece 132 to rotate synchronously. Once the vortex sheet 1353 comes against the blocking wall 1343, the inactive member 1351 and the active member 1352 would generate an asynchronous rotation which fails to rotate the rotation shaft 134. Accordingly, the curtain piece 132 will swing in various angles to close or open the blinds.

Disadvantages associated with the aforesaid conventional blind assembly include:
1. Loud Machine noise generated by an idle running of a driving shaft:
When the transmission shaft 152 drives the driving shaft 135 to rotate, the vortex sheet 1353 is used to defend against the blocking wall 1343, so the rotation shaft 134 is unable to rotate; as a result, the curtain piece 132 swings in various angles to cover or open the curtain. However, once the rotation shaft 134 stops rotating, the obstructing block 1354 (which is on the active member 1352 of the driving shaft 135), and the clasping block 1355 (of the inactive member 1351) would rotate reciprocally. The driving shaft 135 would then generate an idle running. When the driving shaft 135 is idly running, noise inevitably generates from the active member 1352 against the inactive member 1351, coupled with the noise produced by the slide bases 131.
2. NO control over the motor 155 against increasing load when the slide base 131 or the rotation shaft is in position:
For prior arts described above, even when the slide base 131 or the rotation shaft 133 comes to their respective destined position, the motor 155 would still keep running since there is no on/off switch to control its operation, which inevitably results in an increase in powering load and adversely effects the motor 155, which in turn shortens the life of the blind.

### SUMMARY OF THE INVENTION

It is therefore the purpose of this invention to provide a cost-effective compact motor-driven vertical blind with sustained durability and producing little machine noise in operation.

The motor-driven vertical blind in accordance with the present invention comprises (1) a top rail, (2) a plurality of guide members, (3) a plurality of slide sets, (4) a plurality of connection members, (5) a transmission device, (6) a control device, and (7) a limiting device. What distinguishes the present invention from the prior arts lies in the following two added features: a limiting device, and a control device, as stated in more details below.

In this invention, a limiting device is added to a transmission shaft of the vertical blind; while a control device is disposed onto the transmission device. Whenever the curtain pieces (held by a slide base of the transmission device) are being adjusted to swing, the operation of the transmission shaft will be blocked by the limiting device for any abnormal increase in output current of the motor. In the meantime, whenever a control device detects any unexpected value in current that exceeds a set range, an “off” signal is immediately generated to call off any further operation of the motor. As a result, the curtain pieces will swing to the position as expected without making a driving shaft to run continuously. Therefore, the noise generated by the rotation of the transmission shaft is also avoided, which substantially sustains a durable operation of the motor.

The advantages of the present invention over the known prior art will become more apparent to those of ordinary skilled in the art upon reading the following descriptions in conjunction with the accompanying drawings.

### BRIEF DESCRIPTION OF THE DRAWINGS

FIG. 1 is a perspective view illustrating a conventional motor-driven vertical blind;

FIG. 2 is a cross-sectional assembly view illustrating a conventional motor-driven vertical blind;

FIG. 3 is an exploded perspective view of the slide base of a conventional motor-driven vertical blind;

FIG. 4 is a schematic diagram illustrating a transmission device of a conventional motor-driven vertical blind;

FIG. 5 is a perspective view according to a preferred embodiment of the present invention;

FIG. 6 is a block diagram illustrating a control device according to a preferred embodiment of the present invention;

FIG. 7 is a part of cross-section view according to a preferred embodiment of the present invention;

FIG. 8 is a cross-sectional assembly view according to a second preferred embodiment of the present invention;

FIG. 9 is a perspective view according to a second preferred embodiment of the present invention; and

FIG. 10 is a perspective view illustrating a driving shaft according to a second preferred embodiment of the present invention.

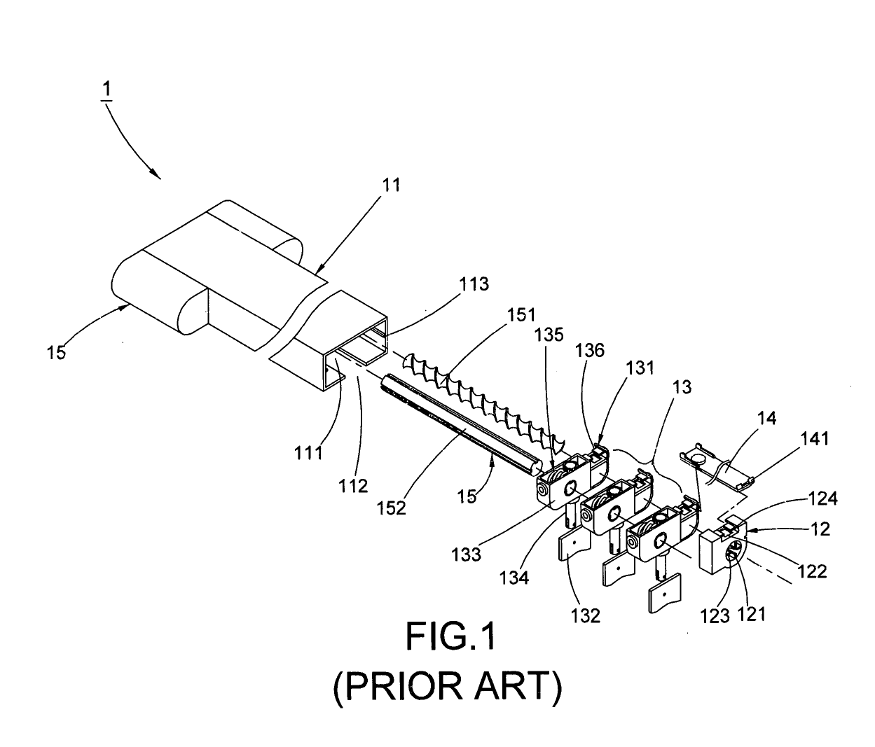

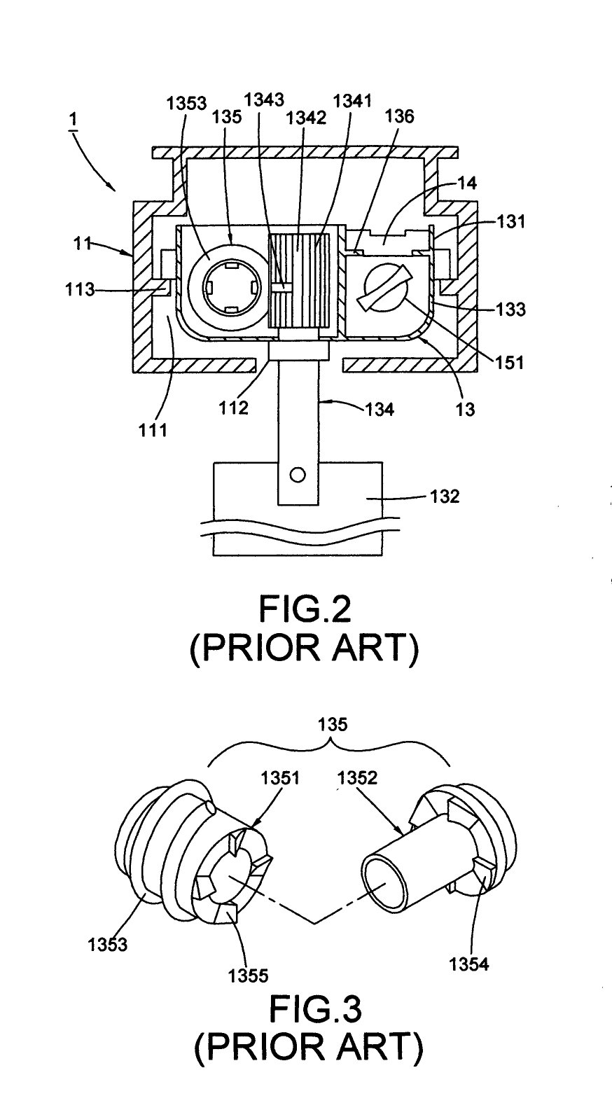

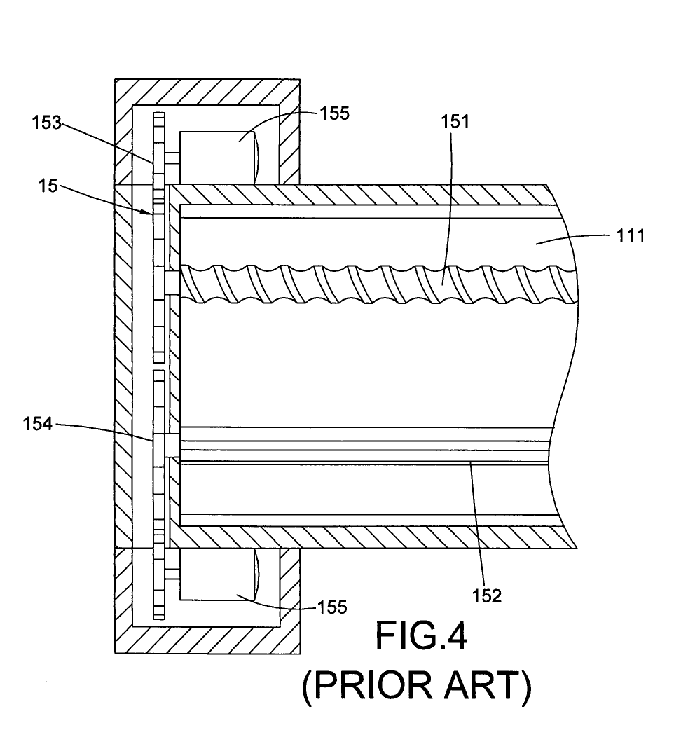

### DETAILED DESCRIPTION OF THE PREFERRED EMBODIMENTS

Wherever possible, the same reference numbers are used in the drawings and the description to refer to the same or like parts.

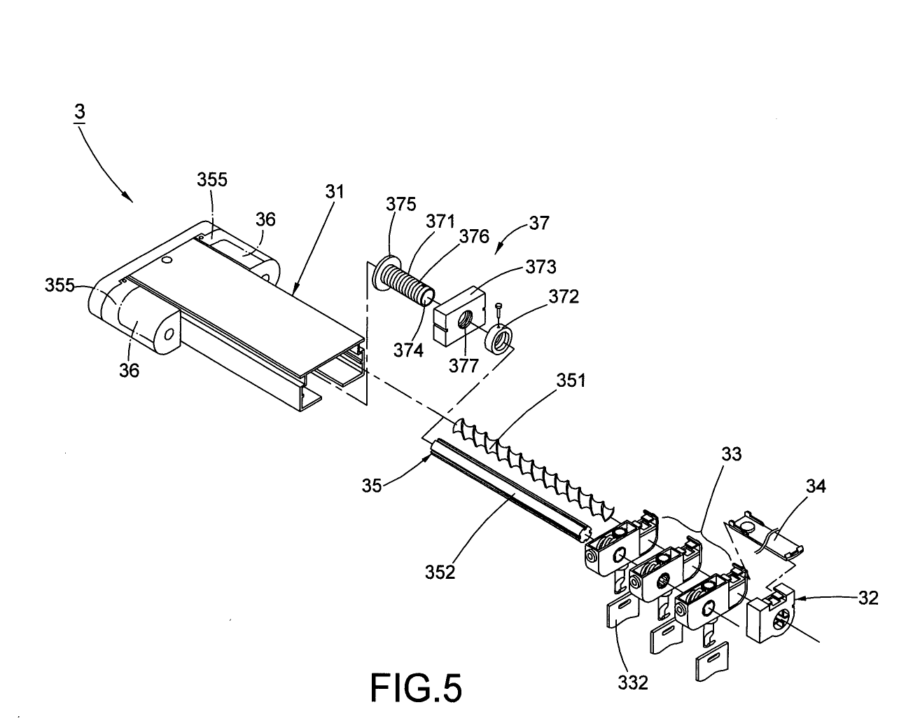

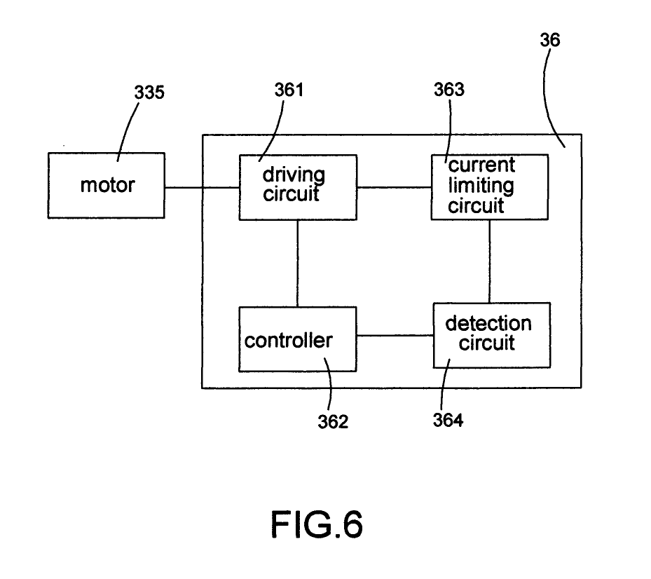

Referring to FIG. 5 and FIG. 6, the present invention of the preferred embodiment comprises

(1) a top rail 31,

(2) a plurality of guide members 32 (only one is illustrated in the figures),

(3) a plurality of slide sets 33,

(4) a plurality of connection members 34 (only one is illustrated in the figures),

(5) a transmission device 35,

(6) a control device 36, and

(7) a limiting device 37.

Among them, the components (1) to (5), i.e., the top rail 31, the guide members 32, the slide sets 33, the connection members 34, and the transmission device 35 are illustrated in the same way as their corresponding prior arts. This invention is distinguishably featured with the control device 36, which further comprises:

(6.a) a driving circuit 361, electrically connected to the motor 355,

(6.b) a controller 362, electrically connected to the driving circuit 361,

(6.c) a current liming circuit 363, disposed between the driving circuit 362 and an external power, and

(6.d) a detection circuit 364, electrically connected to the current limiting circuit 363 as well as the controller 362.

When the detection circuit 364 detects the output current of the current limiting circuit 363 exceeding a predetermined range, a control signal “off” is generated to trigger the controller 362 to control the driving circuit 361 and stop the operation of the motor 355.

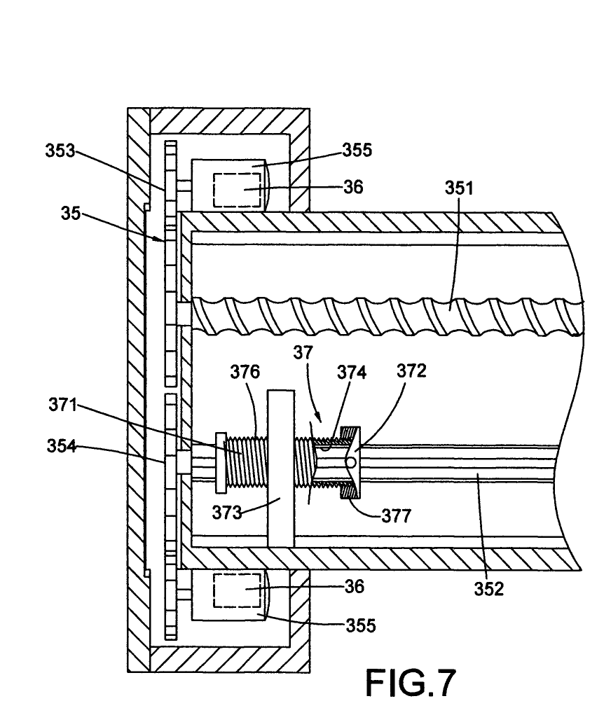

Referring to FIG. 5 to FIG. 7, the limiting device 37 comprises

(A) a position block 371, penetrated through the transmission shaft 352,

(B) a locking block 372, penetrated through the transmission shaft 352 and fastened to the position block 371 thereof, and

(C) a slider 373, disposed between the position block 371 and the locking block 372.

The position block 371 has an opening 374 for the transmission shaft 352 to penetrate through. The position block 371 is fixed over the transmission shaft 352. On one end of the position block 371 forms a blocking portion 375; and a plurality of threads 376 are defined on the outer periphery of the position block 371. The slider 373 has an internal thread 377 for screwing to the threads 376 of the position block 371, so the slider 373 can slide between the blocking portion 375 and the locking block 372, and to further control the rotation of the transmission shaft 352 increasing the output current of the current limiting circuit 363. When the detection circuit 364 detects that the output current of the current limiting circuit 363 exceeds a predetermined range, a control “off” signal is generated to trigger the controller 362 that enables the controller 362 to drive the circuit to stop the operation of the motor 355. The curtain pieces 332 then swings in position to a predetermined angle.

To facilitate the understanding of the actual operation, please refer to the flow chart in FIG. 11. Each arrow in the flow chart indicates a triggering relationship between components.

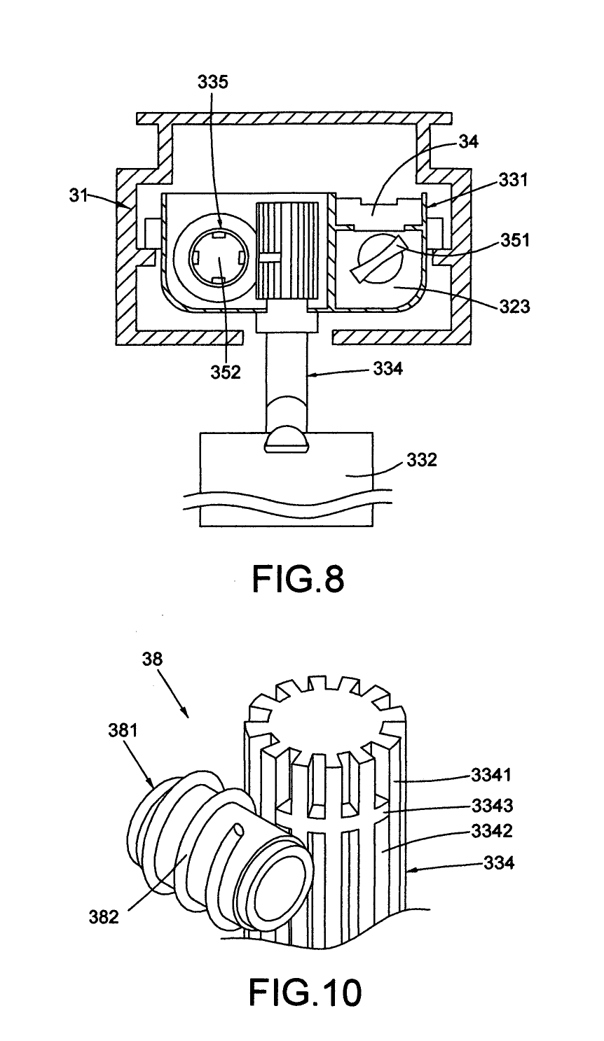

Referring to FIG. 8, while in use, the motor 355 is used to drive the first gear 353 and the second gear 354, rotating the thread shank 351 or the transmission shaft 352, respectively, which in turn rotate the curtain pieces 332 or push the slide base 331 for sliding movement, depending on the user's operation.

For example, while the slide base 331 is driven by the thread shank 351, the motor 355 drives the first gear 353, which further rotates the thread shank 351. Since the thread shank 351 is engaged to the guide block 323, the guide member 32 will be guided by the thread shank 351, which further pushes the connection member 34 to move the slide base 331 on the top rail 31 until the two guide members 32 contact with each other, which may affect the rotation of the thread shank 351. While the detection circuit 364 detects an overload in output current of the current limiting circuit 363, the detection circuit 364 would generate a control signal to trigger the controller 362 to make the driving circuit 361 stop the operation of the motor 355.

While the transmission shaft 352 drives the curtain piece 332 of the slide base 331 to swing for various angles, multiple devices are applied to end the turning movements of the curtain piece 332 when the curtain pieces are turned to a desired position. To be more specific, the motor 355 drives the transmission shaft 352 to rotate, and the transmission shaft 352 synchronously drives the driving shaft 335 and the position block 371. The driving shaft 335 rotates continuously to drive the curtain piece 332 for a swinging angle until the slider 373, which fixed to the position block 371, is moved to contact either the blocking portion 375 or the locking block 372, the rotation of the transmission shaft 352 would be hampered, resulting in an increase of torque at the transmission shaft 352. Accordingly, the output current of the motor 355 will increase. Meanwhile, the detection circuit 364 will also generates a control “off” signal to trigger the controller 362, which controls the driving circuit 361, to stop the operation of the motor 355. The curtain piece 332 will open or fold completely to ensure the curtain piece 332 swing to the position. Noise generated by the rotation of the transmission shaft 352 is reduced significantly and the durability the motor 355 is also enhanced.

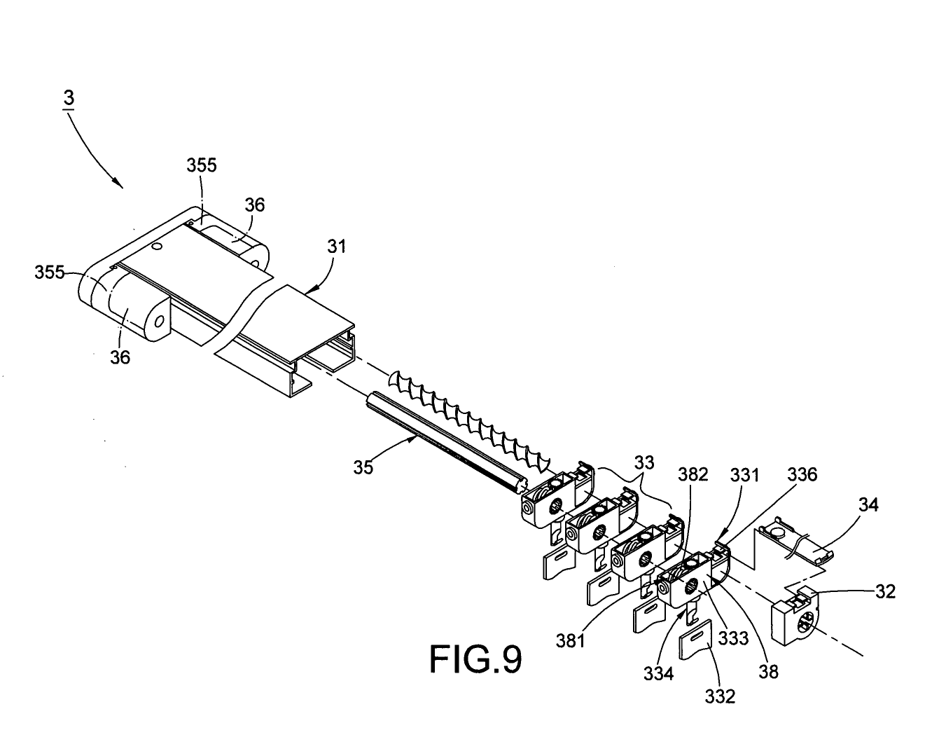

Referring to FIG. 9, a second preferred embodiment of the present invention comprises

(1) a top rail 31,

(2) a plurality of guide members 32 (only one is illustrated in the figure),

(3) a plurality of slide sets 33,

(4) a plurality of connection members 34,

(5) a transmission device 35,

(6) a control device 36, and

(7) a limiting device 38.

The top rail 31, the guide members 32, the slide sets 33, the connection members 34, the transmission device 35 and the control device 36 are illustrated the same as a first preferred embodiment. Also referring to FIG. 10, the limiting device 38 in this second embodiment has a slide base 331, sliding into the contain space 311, and a curtain piece 332, mounted to the slide base 331. The slide base 331 further includes

(A) a base body 333,

(B) a rotation shaft 334, pivotally coupled to the base body 333 and connected to the curtain piece 332,

(C) a driving shaft 381, pivotally coupled to the base body 333 and connected to the rotation shaft 334, and

(D) a fastening block 336, protruding on the base body 333.

A plurality of racks 3341 protrudes from the rotation shaft 334; and a groove 3342 is defined in between every two racks 3341. The blocking walls 3343 are defined on the partial groove 3342. In addition, a vortex sheet 382 surrounds the outer periphery of the driving shaft 381 to rotate and engage with the blocking walls 3343 to impede the driving shaft 381 for rotation.

During operation, the slide base 331 driven by the thread shank 351 is illustrated in the same way as in the first preferred embodiment. When the transmission shaft 352 drives the curtain piece 332 of the slide base 331 for a desired swinging angle, the transmission shaft 352 rotates the driving shaft 381 of the slide base 331 until the vortex sheet 382 of the driving shaft 381 is engaged to the blocking walls 3343 of the rotation shaft 334. Meanwhile, the rotation shaft 334 driven by the driving shaft 381 and drives the curtain piece 332 for a swinging angle. Since the driving shaft 381 cannot be triggered by the transmission shaft 352, the rotation of the transmission shaft 352 is blocked, causing an abnormal increase in torsion of the transmission shaft 352. The output current of the motor 355 will thus increase. As shown in FIG. 6, the detection circuit 364 then generates a control “off” signal to trigger the controller 362 to control the driving circuit 361 to stop the operation of the motor 355.

To sum up, the motor of the transmission device is coupled with a control device. Meanwhile, a limiting device is disposed on the transmission shaft of the transmission device. By sensing an abnormal output current of the limiting device, the control device thereby controls the motor to stop the rotation.

While we have shown and described the embodiment in accordance with the present invention, it should be clear to those skilled in the art that further embodiments may be made without departing from the scope of the present invention.

I claim:

1. A motor-driven vertical blind comprising:
a top rail defining a interior recess, having a channel on said recess for said recess to communicate with the outside;
two guide members adjacently disposed and sliding in said recess: each said guide member having a guide hole with a guide block protruding from the side wall of said guide hole, and a guide groove with a wing rib protruding therefrom;
a plurality of slide sets disposed on both sides of said two guide members, wherein each said slide set having a slide base sliding in said recess and a curtain piece mounted on said slide base, said slide base disposed side by side, each said slide base comprises a base body, a rotation shaft pivotally coupled to said base body and connected to said curtain piece, a driving shaft pivotally coupled to said base body and connected to said rotation shaft, and a fastening block protruding from said base body, wherein a plurality of racks protruding from said rotation shaft, and in between any two racks recesses with a groove and the blocking wall is defined the partial grooves, said driving shaft is composed of a hollow shaped inactive member and an active member which pivotally coupled to each other; a vortex sheet surrounding the outer periphery of said inactive member and a plurality of clasping blocks protruding from said inactive member, a plurality of obstructing blocks disposed on said active member corresponding to said clasping block;
a plurality of connection members and protruding blocks protruding from both side edges of every said connection member;
a transmission device, comprising a thread shank and a transmission shaft disposed in said recess, a first and a second gear connected to both said thread shank and said transmission shaft, and a motor driving said first gear and said second gear;
a control device having a driving circuit electrically connected to said motor, a controller electrically connected to said driving circuit, a current limiting circuit disposed between said driving circuit and an external power, and a detection circuit electrically connected to both said current limiting circuit and said controller; and
a limiting device disposed on said transmission shaft to make said transmission shaft to stop in operation.

2. The motor-driven vertical blind as claimed in claim 1, wherein said limiting device comprises a position block penetrated by said transmission shaft, a locking block penetrated by said transmission shaft and fastened to said position block, and a slider disposed between said position block and said locking block, wherein said position block has a penetrated opening for said transmission shaft to penetrate through, said position is fixed to said transmission shaft, one end of said position block forms a blocking portion, said slider has an internal screw thread for screwing screw threads of said position block for said slider to slide between said blocking portion and said locking block.

3. The motor-driven vertical blind as claimed in claim 1, wherein said limiting device has a slide base sliding in said recess, and a curtain piece mounted on said slide base, wherein said slide base having a base body, a rotation shaft pivotally coupled to said base body and connected to said curtain piece, a fastening block protruding from said base body, wherein a plurality of racks protrude from said rotation shaft, in between any two racks recesses with a groove and the blocking walls is defined the partial grooves, and the vortex sheet surrounds the outer periphery of said driving shaft for restricting the operation of said driving shaft by engaging with said blocking wall.
